(19) United States
(12) Patent Application Publication
(10) Pub. No.: US 2010/0219606 A1
(43) Pub. Date: Sep. 2, 2010

(54) Drive System for Vehicle

(76) Inventor: Gabriel Padilla Orozco, Col. Narvarte (MX)

Correspondence Address: THE WEBB LAW FIRM, P.C., 700 KOPPERS BUILDING, 436 SEVENTH AVENUE, PITTSBURGH, PA, 15219, US

(21) Appl. No.: 12/680,039

(22) PCT Filed: Sep. 25, 2007
(86) PCT No.: PCT/MX07/00109

§ 371 Date: May 7, 2010

(51) Int. Cl. B62M 9/00

(52) U.S. Cl. 280/261

(57) ABSTRACT

A drive system for vehicles which do not use engines or batteries, such as road vehicles, with two or more wheels. The system relies on the incorporation of one or more drive shafts including a common shaft, and two sprockets, one with a fewer number of teeth and another with a greater number of teeth. The shafts extend between the central star and the pinion gear of the vehicle that moves the drive wheel so that the motion from the central star is transmitted to the smaller sprocket by the first shaft, and then from the larger sprocket of the shaft to the smaller sprocket of the next shaft and so on up to the pinion gear. With this system, the vehicle speed is increased many times as the product of relations between larger and smaller gears of each drive shaft in the number of shafts are used.

### FIELD OF THE INVENTION

The present invention is applicable in the field of transport or sports vehicles, mechanically activated by pedals, cranks, wheels or similar, especially vehicles with 2 or more wheels such as bicycles, wheelchairs, boats, etc.

### BACKGROUND OF THE INVENTION

For several years all efforts to improve the movement of the mechanically driven vehicles such as bicycles and the like, has focused on providing lighter materials for construction, in order to give the vehicle a low overall weight, allowing the user to starting it, putting less effort. Furthermore, innovations have been provided so that the complete body of the vehicle can have an easy assembly, including modifications to the systems of shafts, a combination of pulleys, chains and gears without that, to date, any outstanding results has achieved in increasing speed with less effort.

There are some documents disclosing various devices designed to reduce the user effort, including patents from Manuel Soriano, most notably the Spanish Patent No. 1,003.752, which describes a transmission device for non-motorized vehicles, where such device exploits a primary driving force with a high performance and is used primarily for vehicles without engine or mechanisms such as bicycles, skates water or even small pedal cars. This type of system represents a small advantage to the user since he will need to put higher force to start movement of the vehicle, due to the use of rods that form a lever arm, also the position of the pedals implies putting higher effort from the user.

So, also Spanish Utility Model No. 1035695, by Manuel Soriano, describes a device for conversion of reciprocating motion into rotary motion, which includes two levers alternately activated, but its performance is maintained when it is a single lever activated in both tilt directions, so that in both cases, the power applied becomes a constant sense rotary movement of the output shaft. By this invention a relatively higher speed can be achieved if the user has a excellent physical condition, otherwise the physical effort required is extreme. Also, the arrangement proposed here presents a disadvantage in their design since the position of the pedals is uncomfortable. Moreover, the components of this system are susceptible to accelerated wear and therefore an early break of the same, resulting in a significant maintenance cost.

The use of gear systems, connected by string, tape or directly through their teeth to make rapid changes of force, is known as described in U.S. Pat. Nos. 4,397,369, 6,446,985 and 6,446,985 in which, in general, it is proposed to employ a plurality of gears interconnected to transmit the impulse from the pedals to the wheel of a vehicle. Specifically, the '369 U.S. Patent Glenn F. Read, describes a power steering unit for driving a driving mechanism, as for example a tire of a light vehicle such as a bicycle, tricycle or quad, where the mechanism is directed from the output shaft of an engine mounted through a controlled clutch and a chain drivetrain. Preferably the engine is the type of internal combustion with a toothed chain, from which the toothed chain and chain bar have been removed and replaced with an adapter that provides a chain and a belt drive from the engine output shaft of toothed chain to a chain wheel, coupled to a utilization mechanism, such as a conventional bike chain wheel as to drive the rear wheel of the bicycle through the hub of conventional multi-speed or the train of the multi-speed sprocket or alternatively, drive the front wheel of a bicycle through a chain wheel coupled to the front wheel hub, being the front wheel hub preferably a multi-speed hub with internal sprocket. The disadvantages found in the document are: first, for starting the vehicle essential to use an internal combustion engine, and if this engine has not a properly functioning vehicle starting, it will not occur properly, coupled with the fact that the number countless chains and sprockets where chains are assembled is inappropriate, since a larger number of chains functioning would sometimes dependent on the good activity of the chains and sprockets for it.

U.S. Pat. No. 5,061,224 by William B B. Sthuler proposes a torque transmission converting automatic torque of a variable speed bike that uses a belt in a “V” shape with internal teeth that are coupled to the coupling tooth on a pulley inclined variable center at a low speed of high torque on a transformable state into a higher shaft mechanism of infinitely increased variable. This document describes a mechanism that is based on combining gears, pulleys, chains strengths which does not resolve the starting problem and that also employs a system which is comfortable driving for the user but provides poor performance, since initial generated speed is not high.

The patent document U.S. Pat. No. 6,446,985 by Joe Tompsett, describes a two-wheel driving bicycle which has a driving front steering chain mechanism having an array that is geared to the fork set, so that the fork set uses fixed axes and variable axis rotation members transferring rotation power to the front sprocket from the driving mechanism along and around the steering axis. The system proposed in this document contains a number of drawbacks that make it susceptible to all kinds of mechanical problems because the use of a chain longer can occasionally cause stagnation or dislocation of the chain of the path it follows during a cycle bicycle travel as well as that user has to exert more work on the pedal to make an appropriate speed for movement.

In another series of alternatives to increase speed and/or power of a bicycle, thereby facilitating their driving for long periods of time, that is, reducing driver fatigue, there are documents such as the U.S. Pat. No. 1,599,117 by Conlon, in which it is described a bicycle where its rear wheel or traction wheel is given of a mechanism that puts high speed and with less vibration; the device consists of a freewheel or “momentum flywheel” which is located between the bicycle spokes and fixed to the wheel hub; the flywheel includes two semicircular sections joined inside the space between the spokes, such as it is kept out of contact with the users feet. This flywheel has the effect of increasing the momentum of the wheel as it rotates, by the effect of fixed counterweights associated with the flywheel.

The U.S. Pat. No. 2,272,801 of Hawrylasz, mentions that the counterweights are located in some sites on the rim of the drive wheel, either as a continuous ring or as a plurality of counterweights fixed to the rim and spaced equidistantly between the spokes, remaining fixed during movement of the wheel.

A more recent version of this overweight implementation on the drive wheel is in the U.S. Pat. No. 5,507,512 of Donoghue, a document which provides a fairly complete explanation of the effect of excess weight in the performance of the bicycle in terms of preserving and increasing momentum, conservation of angular speed and vibration reduction.

Alternatively, the U.S. Pat. No. 2,580,944 to Nemeth, describes a device that allows the movement to the periphery of the wheel, radial and oppositely, of a pair of counterweights fixed to movable arms respectively, where the projection is performed as an effect of the turning of the wheel, causing the storage of kinetic energy until the weight is shifted, that is the moment when energy is used to help the movement of the bicycle. The text states that the starting period is the one that requires a greater investment of force by the cyclist, at least until a desired speed is achieved, where a device as described comes into operation to maintain the motion of the vehicle at the desired speed without much momentum by the rider. The release of the balances is determined by the strength of a pair of springs, each associated with one of the arms, same to be calibrated to the desired speed.

There are several examples in art of the application of power transmission systems for the conservation of momentum/inertia of a vehicle, including the implementation of mobile counterweights moving from a starting position near the center of rotation, toward the periphery a rotating part. Examples of such applications are U.S. Pat. Nos. 4,179,943 and 4,438,656 Gamba of Hayer, the U.S. Pat. No. 2,232,234 to Hilliard, with balances that are driven by calibrated springs, and in particular the States patent Yamaguchi USA U.S. Pat. No. 5,515,746, which describes a device specifically designed for use on a bicycle and which are not used movable lever arms, but uses a eccentric plaque in communication with the pedal.

Obviously, in all cases the devices will act in a manner that store kinetic energy provided by the rider during the starting phase and released to maintain a desired speed when it is reached. However, the devices are directly dependent of cyclist impulse and have not been used in combination with other devices such as initially specified, to increase the acceleration of this initial phase so that the desired speed is achieved in less time and therefore a lower relative effort.

### SUMMARY OF THE INVENTION

The aim of the present invention is to provide a drive system for a land transport vehicle which allows giving high initial speed in a short time and keep it constant for an extended period of time.

So, too, is an objective of the invention to provide a drive system that requires less energy expenditure and physical fatigue by the user to start the engine for vehicle starting without using electric or combustion engines in order to maintain low operating costs and maintenance.

Moreover with the present invention is intended to help environment preservation by providing a drive system that emits no pollutants to the environment, such as motor vehicles using engine systems such as motorcycles, scooters, skates, etc.

Similarly, the invention aims to provide a vehicle that could be produced at low cost and maintenance of which is also economic.

These and other objectives are achieved through the drive system of the invention which achieves an starting without requiring a major effort, while quickly reaches a high speed, which can be maintained with a sufficient driving force for the vehicle to maintain a constant displacement.

The established objectives are achieved by combining, in a system, various elements such as sprockets, gears, chains, endless chains, and other elements that can solve basic problems related to starting, acceleration and maintaining of a stable speed of conventional vehicles, including elements such as a system of counterweights in the vehicle's traction element, to provide stability and to maintain a steady momentum.

The novel arrangement of the elements of the system of the invention allows the user to wear less in order to achieve the starting of the vehicle and in particular to maintain a considerable speed to move from one place to another making displacements in less time than that taken in the non-motorized vehicles currently known.

In accordance with the principles of the present invention, the counterweights are arranged in at least one of the elements of propulsion of the vehicle—for example at least in the driven wheel of the vehicle—in an arrangement that does not unbalance the vehicle motion, thereby providing a centrifugal force system which operates from the first moment the user starts the vehicle movement. Thus, the system of the present invention can achieve high speeds, for example on a bike speeds of an approach of 100 kilometers per hour can be achieved, depending on the force applied by the user and the pedaling rate.

Thus, the invention provides a drive system that manages to reach high speeds that does not require the use of engines and therefore generates no pollutants to the environment.

### BRIEF DESCRIPTION OF FIGURES

FIG. 1 shows an exploded view of a transmission axis to form a first embodiment of a drive shaft system for vehicles of the present invention;

FIG. 2 shows the transmission axis of FIG. 1 according to the first embodiment of the invention system, installed in a land vehicle;

FIG. 3 is an exploded view of a second transmission axis that, together with the arrangement of FIG. 1, forms a second embodiment of the type of two-axle vehicle drive system for vehicles of the invention;

FIG. 4 shows the layout of the pair of drive sets of the second embodiment of the present invention system, installed in a land vehicle;

FIGS. 5 through 7 show an exploded view of the assemblies that make up the third embodiments of the three-axle vehicle drive system of the invention;

FIG. 8 shows the layout of a third embodiment with three drive sets of the system of the present invention installed on a land vehicle;

FIG. 9 illustrates a system of counterweights of the type known installed on the drive wheel of a land vehicle.

FIG. 10 shows a detail of the arrangement of a counterweight in a drive wheel of a land vehicle, according to the prior art.

FIG. 11 shows a preferred embodiment of the system of counterweights associated with the drive system of the invention.

FIG. 12(a) shows one of the mobile counterweights of the preferred counterweights systems embodiment of the invention.

FIG. 12(b) is an exploded view showing the components of one of the mobile counterweights of the preferred embodiment of the counterweights systems of the invention.

### DETAILED DESCRIPTION OF THE INVENTION

The present invention relates to a drive system for vehicles which do not employ engine or batteries, such as road vehicles, whether with two or more wheels, the system comprises an inertial drive mechanism which provides a means for increasing the speed in a considerably way compared with a similar conventional vehicle, i.e. the speed is increased several times (1, 2, 3 or more times) depending on the number of drive shafts used, each shaft itself being an autonomous and complete mechanism, having said mechanism various objectives as explained below in describing various embodiments of the present invention. In general, each drive shaft in the arrangements as described below, includes an shaft, a pair of gears being one greater than the other, bearings, bearingholders and securing means for the sprockets; the arrangement of said elements on each described drive shaft, will depend on the intended location in the drive system.

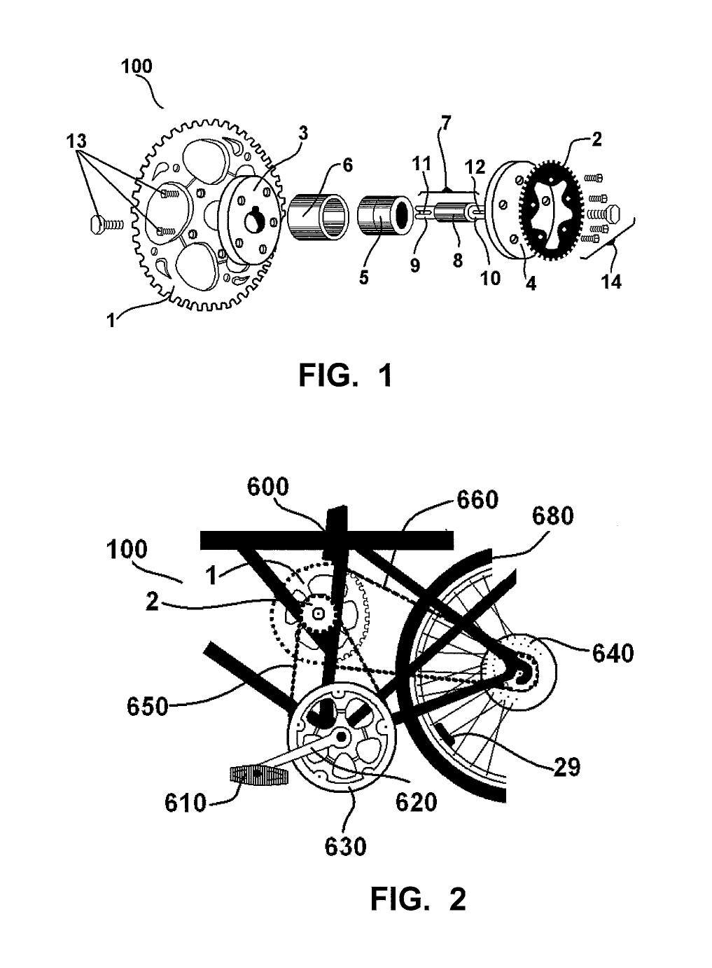

For a better understanding of the invention, the principles of the same applied to a human-powered vehicle, especially on a bike, are described herein. Thus, in a first embodiment of the invention, illustrated in FIGS. 1 and 2, the drive shaft 100 is composed of two sprockets, one with a great diameter 1 and another one with a diameter less than the other 2 (or equivalently, with fewer teeth), two support hubs 3 and 4 on which the sprockets 1 and 2 are fixed, respectively, by fasteners 13 and 14; two bearings 5 inserted inside a bearingholder 6. A shaft 7 with a diameter equal to the diameter of the bearings 5, to which are tightly coupled, under pressure, taking the shaft 7 a length divided into three sections, namely, a central part 8 which supports the bearings 5 and two ends 9 and 10 of smaller diameter which serve to cap and support the support hubs 3 and 4 joined with the two sprockets 1 and 2, where the function of the support hubs 3 and 4 support is to keep the sprockets 1 and 2 perpendicular to the shaft 7, since the sprockets 1 and 2 alone would not have enough lift due the thinness of the material, usually steel. The shaft 7 having further a couple of keyways 11 and 12 formed in each of the ends 9 and 10 respectively, which prevent the sliding of all the support hubs 3 and 4 and the sprockets 1 and 2 when applying a driving force.

The bearingholder 6, keeps the shaft 7 in place and in the exact position required, in addition to allow a perfect bearing of the drive shaft 100 with the shaft 7, support hubs 3 and 4 and sprockets 1 and 2.

FIG. 2 illustrates the arrangement of the elements of the invention according to a first embodiment of a bicycle, where the system includes the drive shaft 100 with the settlement of the shaft 7, the support hubs 3 and 4 and the sprockets 1 and 2 as described above, fixed to the chassis 600 of the vehicle. The drive shaft 100 preferably is attached to the chassis 600 of the vehicle, joining by soldering the bearingholder 6 and the vehicle frame 600 and also including a central star 630 coupled to a pair of cranks 620 (shown in the figure only a crank for better appreciation of other elements), which support pedals 610, being the central star connected 630 to the smaller sprocket wheel 2 by a drive chain 650, so that the drive chain 650 transmits the force applied by the user to pedal 610 and through the crank 620 and the central star 630 to the sprocket 2, while the force is transmitted to the larger sprocket 1 by the shaft 7 and finally through a second drive chain 660 to the pinion gear 640 that transmits the impulse to the drive wheel 680. Through this arrangement an increase in the number of revolutions or turns of the drive wheel 680 according to the ratio between the number of teeth of the larger sprocket 1 and the smaller sprocket 2 is achieved.

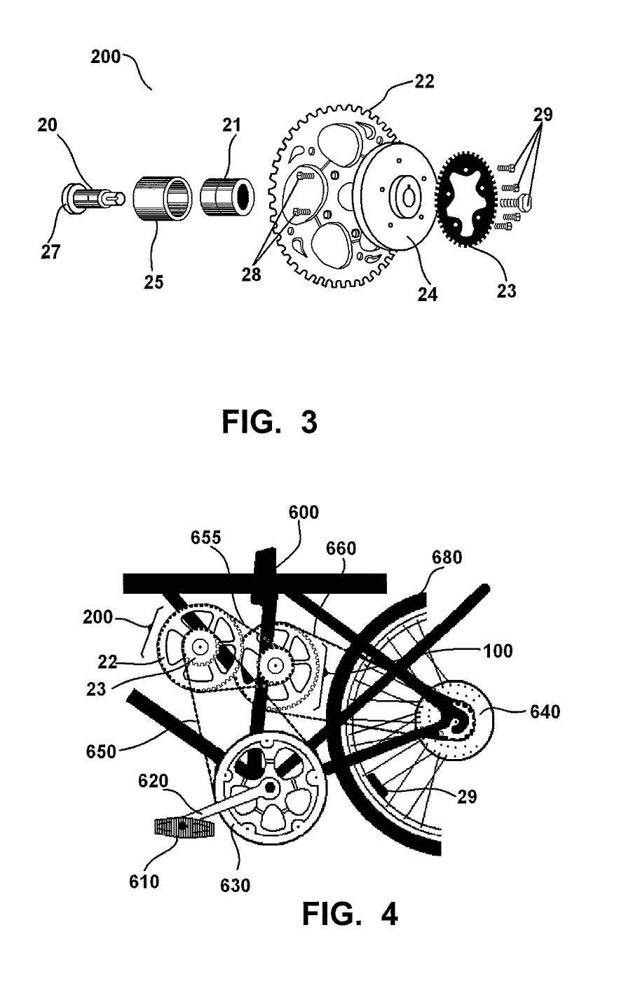

FIG. 3, illustrates a second embodiment of the present invention, which consists of a system according to the first embodiment described above and additionally a second drive shaft 200 consistent of seven elements: an shaft 20 which is adjusted by pressure inside a pair of bearings 21 which in turn are confined within the bearingholder 25, also having the shaft 20 in the section near the end is inserted, a reduction 26 in its diameter, which serves as a cap and that in turn houses a larger set of sprockets larger 22 and smaller 23 joined together by an intermediate support hub 24; the other end of the shaft 20 has a larger diameter section forming an arrow head 27 at shaft 20 and that serves as a cap to prevent movement of the drive shaft out of shaft 20. The sprockets larger 22 and smaller 23 are fastened to support hub 24 by fixing means 28 and 29 respectively.

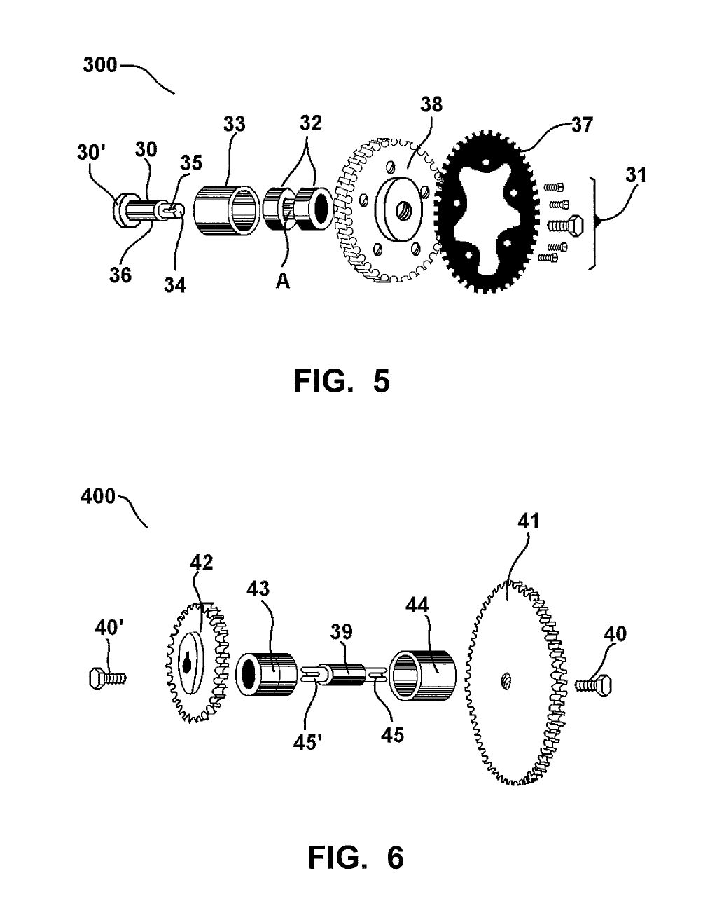

The function of each of the parts of the drive shaft 200 additional in this second embodiment is the same as those of the drive shaft 100 of the previous embodiment, though the drive shaft 200 of this embodiment has a role as an intermediate force transmitter and has a multiplier effect between the generation zone of the driving force, provided directly by the user of the vehicle to operate the crank 620 when driving force is applied on the pedals 610, increasing the speed or smaller sprocket 23 shifts before handing the impulse to further sprocket 22, as shown in the diagram representative of FIG. 5, which shows the shaft of the first embodiment 100 and the shaft 200 according to the second embodiment.

With reference to FIG. 4, it is illustrated a vehicle without a motor and with the system of the second embodiment, comprising a drive shaft 100 of the first embodiment and a drive shaft 200 of the second embodiment. The initial impulse of a user on the pedal system 610, central crank 620 and star 630 is transmitted through a chain forward 650 to the smaller sprocket 23 of drive shaft 200; in turn driving force is relayed directly by the support hub 24 to the larger sprocket 22 by which are linked together. The larger sprocket 22 transmits the driving force to the smaller sprocket 2 of the drive shaft 100, forward through another chain 655. The smaller sprocket 2 of the drive shaft 100 transmits movement through shaft 7 to the other end where it is fixed the larger sprocket 1, the larger sprocket 1 in turn transmits the movement forward through a third chain 660 to the drive wheel 680, yielding a greater impulse to the drive wheel 680.

The total effect of the action of both sets is to rotate the drive wheel 680 of the vehicle with greater speed than that achieved by the effect of a single drive shaft 100 as illustrated in the first embodiment, as there is one more cycle of strength and speed relation between the central star 630 and the pinion gear 640.

A third embodiment of the present invention comprises a drive shaft 300, which by its assembly allows a different configuration to the above mentioned embodiments; FIG. 5 illustrates the components of the drive shaft 300 that consists of 5 elements and fixing means 31, such as screws. The central section of the shaft 30 is of the same diameter as of the inside diameter of the bearings 32 which have a separator between them, to provide greater stability to them in response to the pressure at which they are submitted; said shaft 30 in its first section 36 has a length which enables it to couple with the inside part of the bearings 32, these bearings 32 being received within the bearingholder 33 which help supporting the force applied to start the vehicle movement. Also, at the far end of the shaft 30 is located a smaller diameter section 34 at the end of which has a keyway 35 to hold and avoid slippage of the pair formed by the larger sprocket 38 and the smaller sprocket 37; continuous to the smaller diameter section 34 of the shaft 30, is the main section 36 of the body of the shaft 30 forming a cap that prevents the sliding of the pair of sprockets 37 and 38 who are bound together by fixing means 31, which are adjusted with holes in the greater sprocket 38.

In the drive shaft 300, bearingholder 33 has the function of keeping the bearings 32 in a position to allow full bearing assembly formed by the shaft 30 and the pair of sprockets 37 and 38. The set of bearings 32 and bearingholder 33 is always held in the area 36 of the shaft 30 by the presence of the sprockets 37 and 38 at one end of the shaft 30 and by the head 30′ at the other end.

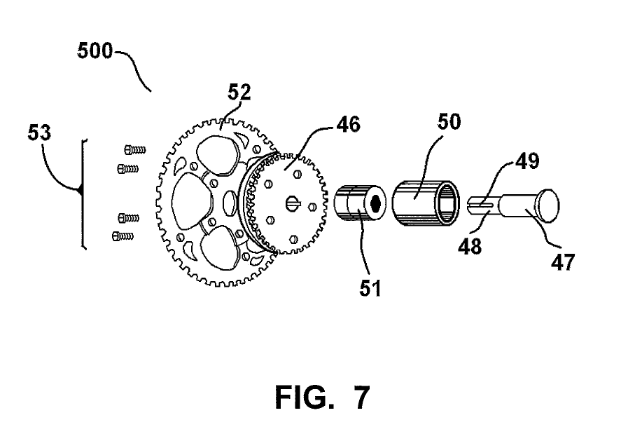

In addition to the set 300, this method requires the use of a drive shaft 400, illustrated in FIG. 6, and a drive shaft 500, illustrated in FIG. 7.

The drive shaft 400 is formed very similarly to the system according to the first embodiment, by the following elements: a shaft 39 that pressure fits into a pair of bearings 43 which in turn are confined within the bearingholder 44, having the shaft 39 in the vicinity of both ends, reductions in diameter 45 and 45′, which serve as a cap, which in turn house respectively, a smaller sprocket 42 and a larger sprocket 41; the central zone of the shaft 39 has a larger diameter in order to fit with the interior of the bearings 43. The smaller sprocket 43 and larger 41 is fastened to the shaft 39 by fixing means 40 and 40′ respectively.

The drive shaft 500 is composed of the following elements: a shaft 47 that pressure fits into a pair of bearings 51 which in turn are confined within the bearingholder 50, having the shaft 47 in one end a reduced diameter 48, which serves as a cap and that in turn houses a set of wheels, where a smaller sprocket 46 and larger sprocket 52 are fixed together by the action of fixing means 53 of the type of screws; the set wheels keeps on reducing 48 of the shaft 47 through keyway 49 in the end of the latter. The shaft 47 has in its opposite end, an expansion that forms a head.

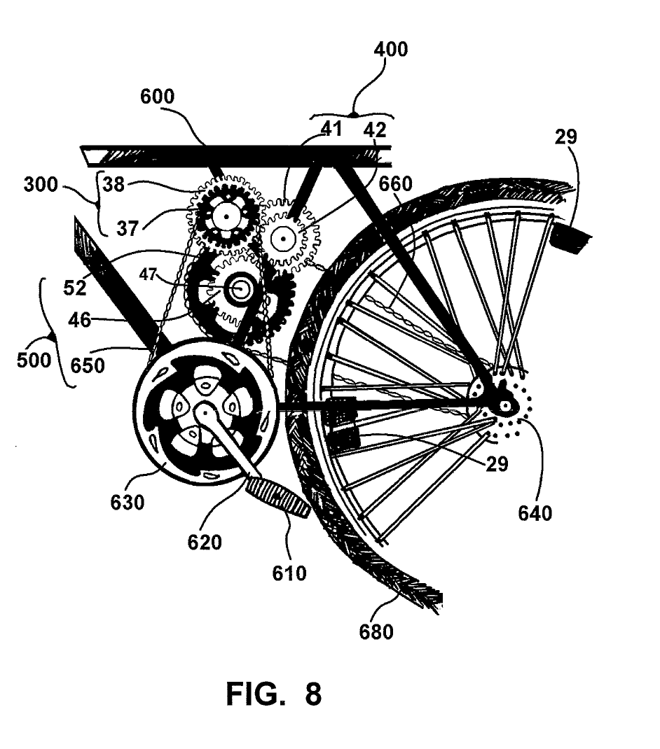

The operation of the third embodiment, including the drive shafts 300, 400 and 500, is illustrated in FIG. 8.

The impulse applied by the user on the pedal 610 is transmitted through the crank toward the central star 630 from where by a chain 650 drives forward the lower sprocket 37 of drive shaft 300; the movement is transmitted to the larger sprocket 38 by the shaft 30, maintaining the same sense of rotation, the lower sprocket 38 of drive shaft 300, in turn, transmits the impulse to the lower sprocket 42 of drive shaft 400 directly, by which it reverses the direction of the motion, which is transmitted to the larger sprocket 41 through the shaft 39. The motion then passed the larger sprocket 41 of drive shaft 400 to the smaller sprocket 46 of drive shaft 500, directly, by which the sense is reversed once more; in the drive shaft 500, through the shaft 47, the movement is transmitted to the larger sprocket 52, from which finally, through chain 660 forward, the wheels are driven by pinion gear 640.

The effect of using the system of the present invention in any embodiment described, in a vehicle driven by the user, such as a bicycle, tricycle, quad, wheelchairs, pedal boat, etc., with a transmission based on sprockets, is described below, taking as example a conventional bike, with wheels of a diameter of 70 cm, and a standard 17-cm crank.

For comparative purposes of the bicycle performance with the drive system of the invention under different conditions, we will refer to some terms defined as follows.

“Development in meters” corresponds to the distance traveled by the bicycle for each rotation of the pedals, essentially depending on the wheel size and number of turns given to the same for each full rotation of a pedal, that at the time is determined by the “transmission ratio”; the length traveled by each turn of the wheel is given by the formula for the perimeter of a circle, that for a wheel with the laid down dimensions, is approximately 2.20 m.

The “transmission ratio” refers to the ratio (n/N) between the number of teeth of two gears (one with fewer teeth, n, and one with more teeth, N) that are in contact relationship, or two sprockets connected by a chain, or the circumferences of two pulleys connected by a drive band. Since the number of teeth is also proportional to the circumference of the gears, the “transmission ratio” can also be expressed as the ratio between the circumferences of both wheels

$$( \frac{d}{D} ) \qquad ( 1 )$$

where d is the diameter of the smaller wheel and D is the diameter of the larger wheel. This relationship provides a measure of the number of turns that one of the gears (the driving gear) produces in the other for every turn that performs; so, for a couple of gears with 15 and 30 teeth, the gear ratio is 15/30 or 1/2, which implies that for each rotation of the lower gear, it produces only half a turn of the larger, or if the larger gear is the driving gear, for each turn of it, there will be two turns of the smaller (2:1 or 2/1). For example, this ratio refers to the central star and the pinion gear that is used in a bicycle gear shifting.

The “cadence” is defined as the number of revolutions per minute of the crank, this is, the rider's pedaling speed in revolutions per minute.

TABLE 1
Speed in km/h achieved with different cadences
and sprockets on a pinion gear of a bicycle

| | Transmis- | Development | Cadence | | | |
|---|---|---|---|---|---|---|
| Gear | sion ratio | in meters | 60 rpm | 80 rpm | 100 rpm | 120 rpm |
| Very | 50:11 | 10.1 | 36 | 48 | 60 | 72 |
| high | | | | | | |
| High | 40:11 | 8.0 | 28.8 | 38.4 | 48 | 57.6 |
| Medium | 28:11 | 5.6 | 20.2 | 26.9 | 33.6 | 40.4 |
| Low | 16:11 | 3.2 | 11.6 | 15.4 | 19.2 | 23.1 |
| Very | 8:11 | 1.6 | 5.8 | 7.7 | 9.6 | 11.6 |
| Low | | | | | | |

Thus, from the table, it is shown that the progress of the bike would start with the gear (or sprocket) with the lowest “transmission ratio” (8:11 or 0.7272/1) implying that for each revolution of the crank, will produce just 72.72% of a rotation of the rear wheel of the bicycle, i.e.:

$$( \frac{8}{11} ) * ( 2.2 \frac{m}{rev} ) = 1.6 \frac{m}{rev} \qquad ( 2 )$$

which corresponds precisely with the “development in meters”. Note that the “transmission ratio” is less than the unity, i.e., the number of teeth on the central star is less than the selected gear on the pinion gear (obviously, this is an illustrative case).

For a conventional cyclist, a cadence of 60 rpm, i.e., a complete lap of the pedal per second, can be considered a mild pace and suitable for a pleasant trip. With this condition, the speed may be achieved using the gear with the lower gear ratio is obtained by:

$$[ ( \frac{8}{11} ) * ( 2.2 \frac{m}{rev} ) ] * ( 60 \frac{rev}{min} ) * [ ( \frac{1 km}{1000 m} ) * ( \frac{60 min}{1 h} ) ] = 5.76 \frac{km}{h} \qquad ( 3 )$$

in general:

[Development in meters]*(Cadence)*[Unitsconvertion] (4)

the same calculations apply to the rest of the table.

Evidently from the table, a higher transmission ratio implies a higher speed if the cadence remains constant in one cycle, and this is reflected in the first term of equations (3) or (4), since the other terms remain constant.

An increased transmission ratio is precisely what is achieved with the implementation of the system of the invention on a bicycle or vehicle of transmission by gears, since all other variables held constant (i.e., for the same bike and one rider), each of the drive shafts that have been described has a multiplier effect of the transmission ratio as:

1. each drive shaft in accordance with the present invention, couples a pair of sprockets, being one of larger size (or number of teeth) and the other of smaller size (or number of teeth),

2. in all cases, the movement is transmitted to the smaller wheel, either by a chain (options 1 and 2) from or through contact (shafts 400 and 500 of the mode 3) with a larger diameter sprocket (or number of teeth), either being this the central star of the bicycle, operated by the pedals, or of other drive shaft,

3. the transmitted movement to the smaller wheel of the transmission shaft produces rotation of the smaller sprocket, which in turn produces the same amount of turns in the larger sprocket of the shaft, since the movement of the smaller sprocket is transmitted directly to the larger sprocket through the corresponding shaft,

4. finally, the motion “comes out” from the transmission shaft by the larger sprocket towards another wheel of small diameter (or number of teeth), being this whether a sprocket of the pinion gear set, or the smaller sprocket than the other drive shaft.

Thus, if we denote by n_{ref} and N_{ref} the number of teeth in the smaller and larger sprockets correspondents to the reference numbers in the accompanying figures and the previous description, we have that the transmission ratios for the bicycle would be given by:

### I. For the Bike Without the System of the Invention

$$( \frac{{N}_{630}}{{n}_{640}} ) \qquad ( 5 )$$

note that n₆₄₀ is referred to any wheel that form the pinion gear, and for comparison, should be the same in the cases compared.

### II. Embodiment 1 with the Drive Shaft 100

Since the movement provided by the rider to pedal and transmitted by him to the central star 630 is transmitted to the smaller sprocket 2 of the drive shaft 100 via chain 650, as illustrated in FIG. 2, the first transmission relationship is produced between these two elements 630 and 2; the smaller sprocket 2 then turns to the larger sprocket 1 in a direct link through the shaft 7, and the larger sprocket 1 finally transmits motion to the pinion gear 640 by chain 660, setting the second transmission ratio 1-640, so we have:

$$[ ( \frac{{N}_{630}}{{n}_{2}} ) * ( \frac{{N}_{1}}{{n}_{640}} ) ] \qquad ( 6 )$$

which can be rearranged to:

$$[ ( \frac{{N}_{630}}{{n}_{640}} ) * ( \frac{{N}_{1}}{{n}_{2}} ) ] \qquad ( 7 )$$

so the vehicle speed would be increased, keeping other factors constant, in an amount equal to the ratio between the number of teeth on the smaller sprocket 2 and the number of teeth on the larger sprocket shaft 2 of the drive shaft 100 intermediate to the central star 630 and the pinion gear 640 that moves the wheel 680. It is said that there is an increase because the factor N₁/n₂ is always greater than unity.

### III. Embodiments 2 with the Drive Shafts 100 and 200

Applying the same reasoning as in the above description, we have that, in a system that integrates two drive shafts, as illustrated in FIG. 4:

$$[ ( \frac{{N}_{630}}{{n}_{23}} ) * ( \frac{{N}_{22}}{{n}_{2}} ) * ( \frac{{N}_{1}}{{n}_{640}} ) ] = [ ( \frac{{N}_{630}}{{n}_{640}} ) * ( \frac{{N}_{1}}{{n}_{2}} ) * ( \frac{{N}_{22}}{{n}_{23}} ) ] \qquad ( 8 )$$

in this case, the vehicle speed would be increased, keeping other factors constant, in an amount equal to the product of the relationship between the number of teeth of the sprockets larger and smaller of the two intermediate drive shafts.

### IV. Embodiment 3 with the Drive Shafts 300, 400 and 500

Following the same reasoning, a system that integrates three shafts, as illustrated in FIG. 8,

$$[ ( \frac{{N}_{630}}{{n}_{37}} ) * ( \frac{{N}_{38}}{{n}_{42}} ) * ( \frac{{N}_{41}}{{n}_{46}} ) * ( \frac{{N}_{52}}{{n}_{640}} ) ] = [ ( \frac{{N}_{630}}{{n}_{640}} ) * ( \frac{{N}_{38}}{{n}_{37}} ) * ( \frac{{N}_{41}}{{n}_{42}} ) * ( \frac{{N}_{52}}{{n}_{46}} ) ] \qquad ( 9 )$$

vehicle speed would be increased, keeping other factors constant, in an amount equal to the product of the relationship between the number of teeth of the sprockets larger and smaller of the three intermediate drive shafts. Note that always the relations of each drive shaft are greater than unity so that, there is an increase of the speed according to equation (4).

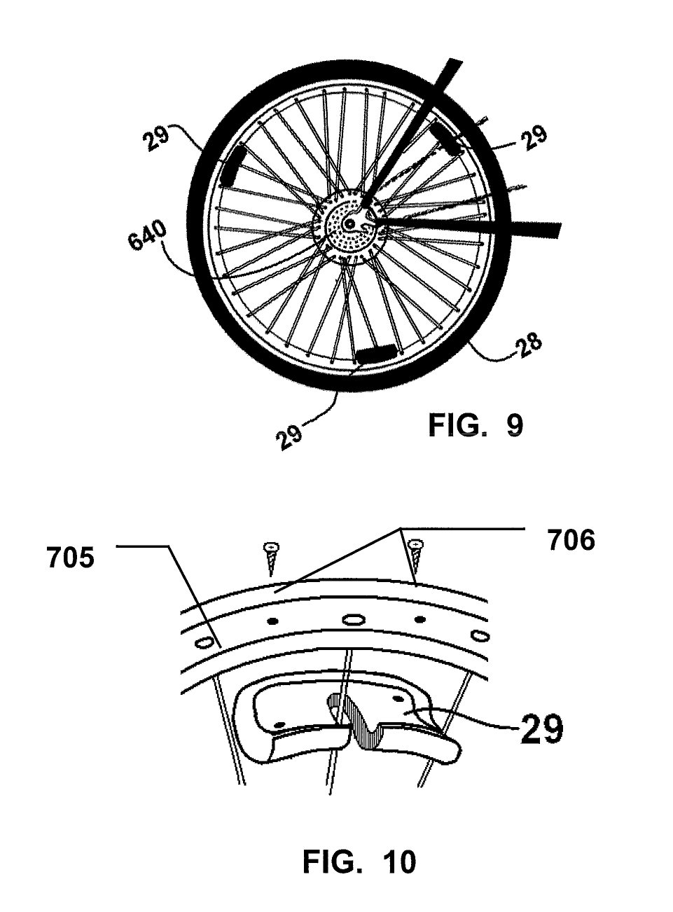

FIGS. 9 and 10 illustrates a conventional system of counterweights as described in the prior art, where each counterweight (29) is attached directly to the rim (705) of the drive wheel, conventionally, the rear wheel of a bicycle, and the plurality of counterweights is distributed equidistant around the rim. FIG. 9 illustrates a 3-counterweights system, and FIG. 10 illustrates one possible way of securing the counterweight (29) to rim (705), using fasteners such as auto-threaded screws (706).

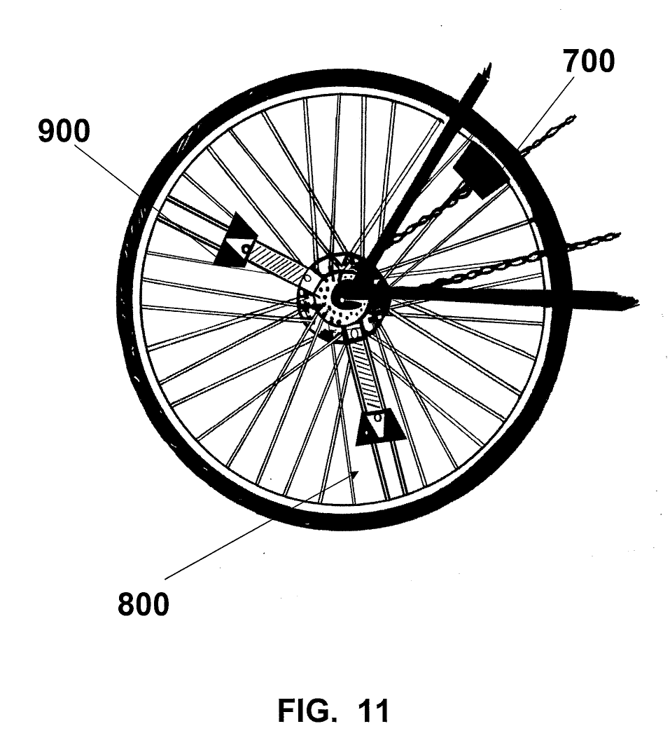

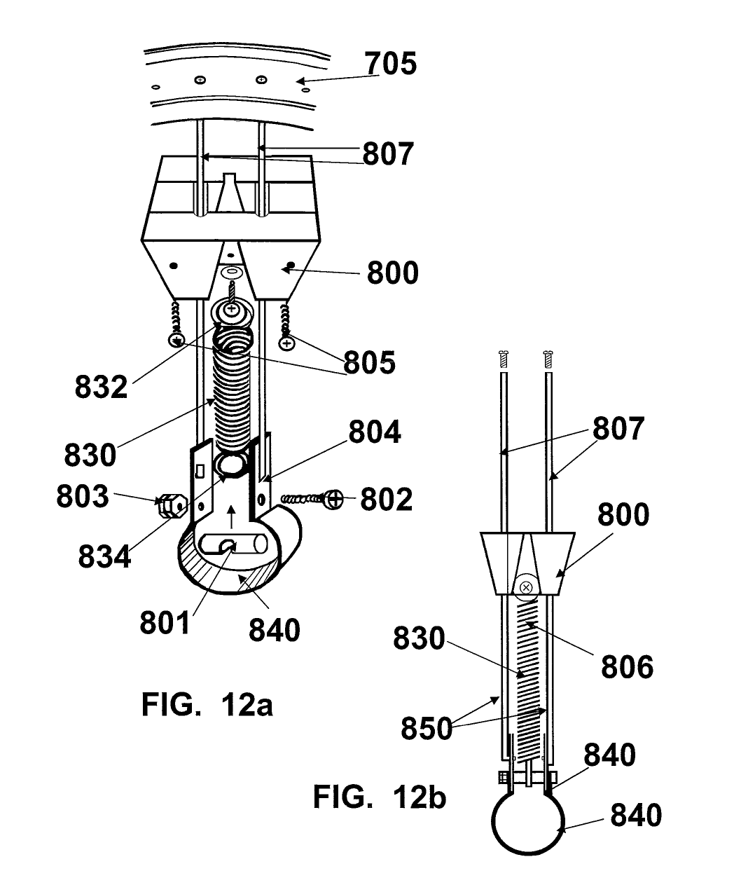

In the preferred embodiment of the invention, the drive system described above is complemented by a set of counterweights to optimize use of the momentum gained by the drive system. The counterweight system, illustrated in FIGS. 11, 12(a) and 12(b), is designed to be incorporated into the wheels that contains the vehicle in order to maintain the speed of the same once the impulse is applied on the system shaft of the present invention. The increased speed gained with the system of the invention, added to the presence of the counterweights, leads to the effect of maintaining the impulse or momentum of the vehicle, requiring less effort by the user for movement.

The counterweights are a functional system that may include three or more counterweights depending on the characteristics of the vehicle concerned, recommending the use of three equally spaced counterweights, each with its own characteristics. The counterweights that are used as in the preferred embodiment of the invention have different weights that are progressive, for example, 900, 700, 500 grams, to ensure optimum efficiency.

The first counterweight (700), of 900 g in our example, is fixed to the rim (705) of the rim such as shown in prior art FIG. 10, and it is precisely this counterweight the one that generates the agile starting of the vehicle.

The second counterweight (800) and the third counterweight (900), took in the direction of rotation of the wheel forward, are mobile and are constituted basically the same way, so their description is based on the first, with illustrative purposes.

The mobile counterweight (800) illustrated in FIGS. 12(a) and 12(b) consist of a piece (810), with two parallel grooves that move from the larger base towards the smaller, with an equal distance between them. The parallel internal channels which serve to accommodate two rods that are bicycle spokes parallel to each other, holding the mobile counterweight mechanism to the rim (705), so the counterweight can slide; these rods (807) have a threaded end to hold on to the rim (705) with two fasteners elements of the rods (807) that, passing through two holes made especially for this purpose, and at its opposite end showing an orifice plaques (804) to join the hub of the wheel through a clamp (840) for which are connected by a screw (802) and nut (803) and a tubular separator (801) between the ends of the bracket (840) which keeps the rods (807), that are two bicycle spokes, at a given distance; a spring (830) is fixed to the tubular separator (801) of the clamp (840) at one end (834) and on the other (832) to the counterweight (800) by means of appropriate fixation elements, such as a screw (806) with washer. The mobile counterweight springs differ in their calibration.

When the vehicle starts its movement, the spring of the second counterweight (800) similar to that of the third (900), is contracted, so the counterweight does not generate any additional centrifugal force provided by the user and the drive system selected from among the previously described embodiments.

In the starting phase, only the first of the counterweights (700) provides an additional impulse to the rear wheel by centrifugal force concentrated at a single point, making starting very efficient. When speeds between 13 and 15 km/h are reached, wheel vehicle starts to “pitch”, so to avoid this situation, the spring of the second counterweight (800) is calibrated so that the counterweight (800) can slide to the rim (705) of the tire, providing additional impulse due the mass increased perimeter. When the vehicle is about to reach 20 km/h comes into operation the spring of the third counterweight (900).

The combined effect of the drive system selected from the embodiments described and the system for increased torque represented by the set of counterweights in the drive wheel, allows the user or operator of a human-powered vehicle in question, only to make a considerable effort in the starting phase of the vehicle, diminishes its effort when increasing the speed, because of the support provided by the counterweights, until the desired speed is achieved, where the counterweights provide an efficient inertial system.

It is important to note that, although the description of the present invention relates primarily to improvements in the drive system of a human-powered vehicle and particularly to the construction of drive shafts, it is necessary to simultaneously include each of the elements in the different embodiments as described previously.

1. A drive system for a human-powered vehicle, of the type that uses a transmission based on sprockets and chains, such as a bicycle, tricycle, quad, or similar, where the drive system comprises at least one drive shaft that is inserted between a central star next to a pedal and a pinion gear attached to a driven wheel, wherein each of the drive shafts comprises:
i. a shaft, with a main body and one or more areas with reduced diameters,
ii. a pair of sprockets, one being larger than the other, that are attached to the shaft in areas set aside for that purpose, defined by a reduction in the diameter of the shaft and fixed in position by the action of which are keyways coupled to the sprockets;
iii. wherein the main body of the shaft, with no reduction in diameter, is adjusted to the inside of the bearings and these in turn into the bearingholder, so that the whole shaft and sprockets turn freely about the bearingholder which, in turn, serves to hold the assembly to the vehicle structure; and
iv. wherein the set is fixed to the vehicle structure so that the smaller diameter sprocket receives the movement provided by the impulse of the user on the pedal of the bike and of the latter through the crank to the central star of the bicycle, either directly from the central star or from the larger sprocket of another drive shaft through an endless chain or by direct action;
wherein such motion received by the smaller diameter sprocket in a drive shaft is transmitted through the shaft to the larger sprocket of said drive shaft, in order to give motion to a smaller sprocket either of the vehicle pinion gear or of another drive shaft through an endless chain or by direct action, where it provides a multiplier effect to the transmitted motion, in an amount equal to the product of the relationship between the number of teeth of the sprockets of the major and minor intermediate shafts employed;
and wherein the drive system includes a plurality of counterweights on the drive wheel of the vehicle that act differentially depending on the vehicle speed, in order to provide balance and maintenance of vehicle motion during operation.

2. The drive system for a human-powered vehicle in accordance with claim 1, wherein a drive shaft is used for transmission between the central star and the pinion gear, and wherein said drive shaft,
a. presents the sprockets located at the ends of the shaft,
b. the bearingholder lies between the two sprockets,
c. the outer surface of the bearingholder is used to attached it by welding to the vehicle structure, so that the smaller wheel can receive the movement from the central star by an endless chain and the larger wheel can transmit motion to the pinion gear through another endless chain.

3. The drive system for a human-powered vehicle in accordance with claim 2, wherein the sprockets are fixed in corresponding support hubs, that provide stability and rigidity for efficient transmission of motion.

4. The drive system for a human-powered vehicle in accordance with claim 1, further including an additional drive shaft between the central star and the first drive shaft.

5. The drive system for a human-powered vehicle, according to claim 4, wherein in the additional drive shaft,
I. sprockets are fixed between them at one end of the shaft, through an intermediate hub to which are fixed by fixing means;
II. the outer surface of bearingholder is used to attach it to the vehicle structure so that the motion of the central star is transmitted freely to the smaller sprocket of said drive shaft by means of an endless chain;
III. motion is then transmitted from the larger sprocket of the additional drive shaft toward the smaller sprocket of the first drive shaft through a second chain; and
IV. the motion is transmitted from the larger sprocket of the first drive shaft to the pinion gear, by a third endless chain.

6. The drive system for a human-powered vehicle in accordance with claim 1, wherein it uses three drive shafts between the central star and the pinion gear, where:
a) a first drive shaft has the sprockets located in one same end of the shaft holding each other by fixing means such as screws,
b) the bearingholder is located at the other end of the shaft, and the outer surface of the bearingholder is used to attach it by welding to the vehicle structure so that the smaller sprocket can receive the motion from the central star through an endless chain and the larger sprocket can transmit motion to the smaller sprocket of the second drive shaft through direct contact, then reversing the direction of motion;
c) a second drive shaft features sprockets located at the ends of the shaft,
d) the bearingholder lies between the two sprockets, and the outer surface of the bearingholder is used to attach it by welding to the vehicle structure so that the smaller sprocket can receive the motion through direct contact from the larger sprocket of the first drive shaft,
e) the larger sprocket transmits movement to the smaller sprocket of a third drive shaft through direct contact, again reversing the direction of motion,
f) a third drive shaft presents sprockets located together at one end of the shaft,
g) the bearingholder is located at the other end of the shaft, and the outer surface of the bearingholder is used to attach it by welding to the vehicle structure so that the smaller sprocket of the third shaft can receive movement through direct contact from the larger sprocket of the second drive shaft, and
h) the larger sprocket can transmit motion to the pinion gear through another endless chain.

7. The drive system for a human-powered vehicle in accordance with claim 1, wherein it uses between 2 and 6 counterweights, preferably 3, distributed equidistantly in the drive wheel of the vehicle.

8. The drive system for a human-powered vehicle in accordance with claim 7, wherein the weights of these counterweights are in a ratio of 9:7:5, as for example, 900, 700 and 500 grams, respectively.

9. The drive system for a human-powered vehicle in accordance with claim 8, wherein the heavier counterweight is fixed to the rim of the drive wheel of a vehicle by fasteners such as screws.

10. The drive system for a human-powered vehicle, according to claim 8, wherein the lighter counterweights are mobile-installed between a retracted position near the hub of the traction wheel and an extended position close to rim of the traction wheel.

11. The drive system for a human-powered vehicle in accordance with claim 10, wherein each mobile counterweights has a mechanism to bring them from the retracted position to the extended position.

12. The drive system for a human-powered vehicle, according to claim 11, wherein the mechanism related with the mobile counterweights includes:
a. a clamp for holding the mechanism to the cube of the drive wheel of the vehicle,
b. a pair of bicycle spokes that extend parallel to each other by way of modified bicycle spokes from the clamp to the rim of the traction wheel, and
c. a spring located between the pair of parallel rods, with one of its ends attached to the clamp and the other end being attached to the body of the moving counterweight.

13. The drive system for a human-powered vehicle in accordance with claim 12, wherein the clamp grips one end of the rods and one end of the spring, through a screw and a nut which also allows the fixation of the clamp to the hub of the drive wheel.

14. The drive system for a human-powered vehicle in accordance with claim 11, wherein each counterweight essentially has a trapezoidal shape, which includes two channels that extend perpendicularly to the base, equidistantly from each other.

15. The drive system for a human-powered vehicle, according to claim 12, wherein the rods of the motion mechanism are passed through the tubular ducts of the counterweight, so that the counterweight can slide freely along the rods.

16. The drive system for a human-powered vehicle in accordance with claim 15, wherein the free end of the spring is attached to the counterweight body by suitable fixing means, such as a screw, so that the counterweight maintains a position close to the clamp when the spring is effort-free, and it slides towards the rim of the drive wheel when the spring is subjected to a determined effort.

17. The drive system for a human-powered vehicle, according to claim 11, wherein the motion mechanism of one of the counterweights is calibrated so that a counterweight of 700 grams can move to the end of the rim of the drive wheel when the vehicle speed reaches a predetermined speed.

18. The drive system for a human-powered vehicle, according to claim 17, wherein the predetermined vehicle speed is between 13 and 15 km/h.

19. The drive system for a human-powered vehicle, according to claim 11, wherein the spring for the motion mechanism of one of the counterweights is calibrated so that a counterweight of 500 grams can move to the end of the rim of the driven wheel when the vehicle speed reaches a predetermined speed.

20. The drive system for a human-powered vehicle in accordance with claim 19, wherein the predetermined vehicle speed is 20 km/h.
